(19) United States
(12) Patent Application Publication
(10) Pub. No.: US 2010/0123383 A1
(43) Pub. Date: May 20, 2010

(54) DUAL-PURPOSE LIGHT-PENETRATING AND LIGHT-EMITTING DEVICE AND LIGHT-PENETRATIVE ILLUMINATING STRUCTURE

(75) Inventors: Jung-Yu Li, Taipei County (TW); Shih-Pu Chen, Hsinchu City (TW); Yi-Ping Lin, Changhua County (TW); Yen-I Chou, Hsinchu City (TW); Po-Hung Wang, Kaohsiung County (TW); Ming-Chung Liu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/365,865

(22) Filed: Feb. 4, 2009

(30) Foreign Application Priority Data
Nov. 14, 2008 (TW) 97144168

(51) Int. Cl. H01J 63/04

(52) U.S. Cl. 313/491

(57) ABSTRACT

A dual-purpose light-penetrating and light-emitting device is provided. The dual-purpose light-penetrating and light-emitting device includes a first transparent substrate, a spacing sidewall, a second transparent substrate, and a light-penetrative illuminating structure. The spacing sidewall is disposed between the first transparent substrate and the second transparent substrate for configuring a hermetic space. The light-penetrative illuminating structure includes a cathode structure, an anode structure, a low pressure gas layer, and a patterned fluorescent layer. The low pressure gas layer is accommodated in the hermetic space. The cathode structure and the anode structure are oppositely disposed on the first transparent substrate and the second transparent substrate, respectively. The patterned fluorescent layer is positioned between the cathode structure and the anode structure, for allowing an ambient natural light penetrating therethrough.

### CROSS-REFERENCE TO RELATED APPLICATION

This application claims the priority benefit of Taiwan application serial no. 97144168, filed on Nov. 14, 2008. The entirety of the above-mentioned patent application is hereby incorporated by reference herein and made a part of this specification.

### BACKGROUND OF THE INVENTION

1. Field of the Invention

The present invention generally relates to a flat light-emitting device, and more particularly, to a dual-purpose light-penetrating and light-emitting device and a light-penetrative illuminating structure.

2. Description of Related Art

Light sources are very widely used in daily life. After being researched and developed for a long period, flat light-emitting devices featured with lower power consumption and more uniform illumination have been evolved from conventional dot light sources. Such flat light-emitting devices can be widely used in flat panel displays, advertising boards for large buildings, or building used illumination.

As a light-penetrative material, glass has been popularly used as a building material by current green concept buildings. Glass has the advantages like long lifespan, and convenience of maintenance. Glass material allows providing the sunlight for facilitating the indoor illumination in daytime. As such, it is helpful for saving electricity consumed for illumination, and providing comfort and natural illumination space. When determining to use the glass material, except the aperture ratio (light penetrating), the factor of heat isolation should also be considered. Specifically, in the summer, about 70% of heat is exchanged between the indoor environment and the outdoor environment via glass windows, while in the winter, about 40% of heat is lost from the indoor environment to the outdoor environment via the glass windows. Apparently, glass windows having a greater aperture ratio will cause more heat entering from the outdoor environment to the indoor environment in the summer, and more heat lost from the indoor environment to the outdoor environment in the winter. Both of these two situations necessarily lead to an increase of electricity consumed by air conditioners. Nowadays, we are living in a time of saving energy and reducing emissions, and are frustrated by the green house effect, and high oil price. Therefore, it is a very important and economically valuable subject to develop a heat isolation glass for saving the electricity consumed for illumination and by air conditioners.

Further, considering the application in scenario, the natural light in daytime is usually a uniform light, and people are likely to feel natural and comfort in such an environment. However, in the evening or the night, comparing with the daytime, the light is much less provided, and therefore a fully darkness outside the window often makes the host upset. As such, if the illumination effect in the evening and the night can be provided similar as the daytime having the natural light illuminated over the glass windows, the host would be brought to a safe and calm mood.

### SUMMARY OF THE INVENTION

Accordingly, the present invention is directed to provide a dual-purpose light-penetrating and light-emitting device. The dual-purpose light-penetrating and light-emitting device is adapted for allowing a natural light penetrating therethrough in the daytime and providing an illumination in the night.

The present invention is further directed to provide a light-penetrative illuminating structure. The light-penetrative illuminating structure is adapted for allowing a natural light penetrating therethrough in the daytime and providing an illumination in the night.

The present invention provides a dual-purpose light-penetrating and light-emitting device. The dual-purpose light-penetrating and light-emitting device includes a first transparent substrate, a spacing sidewall, a second transparent substrate, and a light-penetrative illuminating structure. The spacing sidewall is disposed between the first transparent substrate and the second transparent substrate for configuring a hermetic space. The light-penetrative illuminating structure includes a cathode structure, an anode structure, a low pressure gas layer, and a patterned fluorescent layer. The low pressure gas layer is accommodated in the hermetic space. The cathode structure and the anode structure are oppositely disposed on the first transparent substrate and the second transparent substrate, respectively. The patterned fluorescent layer is positioned between the cathode structure and the anode structure, for allowing an ambient natural light penetrating therethrough.

The present invention further provides a light-penetrative illuminating structure. The light-penetrative illuminating structure includes a cathode structure, an anode structure, a patterned fluorescent layer, and a low pressure gas layer. The cathode structure and the anode structure are oppositely disposed. The patterned fluorescent layer is positioned between the cathode structure and the anode structure. The patterned fluorescent layer allows an ambient natural light penetrating therethrough. The low pressure gas layer is filled between the cathode structure and the anode structure, for inducing the cathode structure to emit a sufficient quantity of electrons.

The present invention employs the patterned fluorescent layer for emitting light, and allows the natural light penetrating therethrough during the daytime. As such, the present invention has the function of light penetrating and light emitting, and is adapted for application of windows of residences or buildings. The present invention has the feature of light-penetrating and heat isolation, so that it is adapted for saving a great share of cost spent on electricity consumed by air conditioners or illumination in daytime. The present invention also has the feature of light-emitting, so that it is further adapted for providing indoor illumination. Therefore, the present invention is adapted for many applications.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1C are cross-sectional views of a dual-purpose light-penetrating and light-emitting device, according to three embodiments of the present invention, respectively.

FIGS. 2A through 2C are cross-sectional views of a cathode structure, according to three embodiments of the present invention, respectively.

FIGS. 3A and 3B are cross-sectional views of an anode structure, according to two embodiments of the present invention, respectively.

FIGS. 4A through 4C are top views of a patterned fluorescent layer, according to three embodiments of the present invention, respectively.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides a dual-purpose light-penetrating and light-emitting device. According to a light-emitting mechanism of a flat electron emission lamp (FEEL), the present invention utilizes a gas under a low pressure condition to guide a sufficient quantity of electrons out from a cathode, and accelerates the electrons with an electrical field to fly in the thin low pressure gas. Typically, an electron usually has a longer mean free path in a low pressure gas. As such, there are enough energy of electrons directly bombard the fluorescent powders on the anode. In such a way, the kinetic energy of the electrons is converted into light energy, thus emitting light thereby.

Further, the light-emitting mechanism of the FEEL can be accorded to achieve characteristics and advantages which cannot be achieved by other light sources. For example, the FEEL has the features of transparency and double emission. The wavelength of the light emitted by the FEEL is determined by the ingredients of the fluorescent material of the FEEL. As such, the FEEL can be designed to achieve desired wavelength range by modifying the ingredients of the fluorescent material. Further, the FEEL has the superior characteristics of short light emitting response time, and a linear adjustability of light, and therefore can be adapted for different requirements in accordance with different environments. As to the ergonomics and visual comfort factors of the FEEL, the light emitted from the flat light source thereof has the advantage of lower light intensity per unit area, and the FEEL does not emit any dazzle light. Comparing with a conventional dot light source, the FEEL does not cause any glaring persistence of vision, and is well matched with the basic requirement for people's health and indoor illumination. In fabrication process of a FEEL, there is not any semiconductor or organic chemical contamination associated. The FEEL, itself, does not contain any mercury, and is an environment-friendly green light source, and matches the future environmental protection requirement. As such, in addition to providing the illumination in the night, the light-emitting mechanism of the present invention can further allow the daytime natural light penetrating therethrough, and thus can be used as a dual-purpose light-penetrating and light-emitting device. The present invention employs transparent substrates made of hard materials or flexible materials. The light-penetrating and light-emitting device can be configured as a planar plane or a curve plane, in accordance with the practical desire. Reference will now be made in detail to the present preferred embodiments of the invention, examples of which are illustrated in the accompanying drawings. However, the present invention should not be construed as exactly as shown in the embodiments. The embodiments may be modified by those skilled in the art according to the spirit of the present invention embodiment in the embodiments.

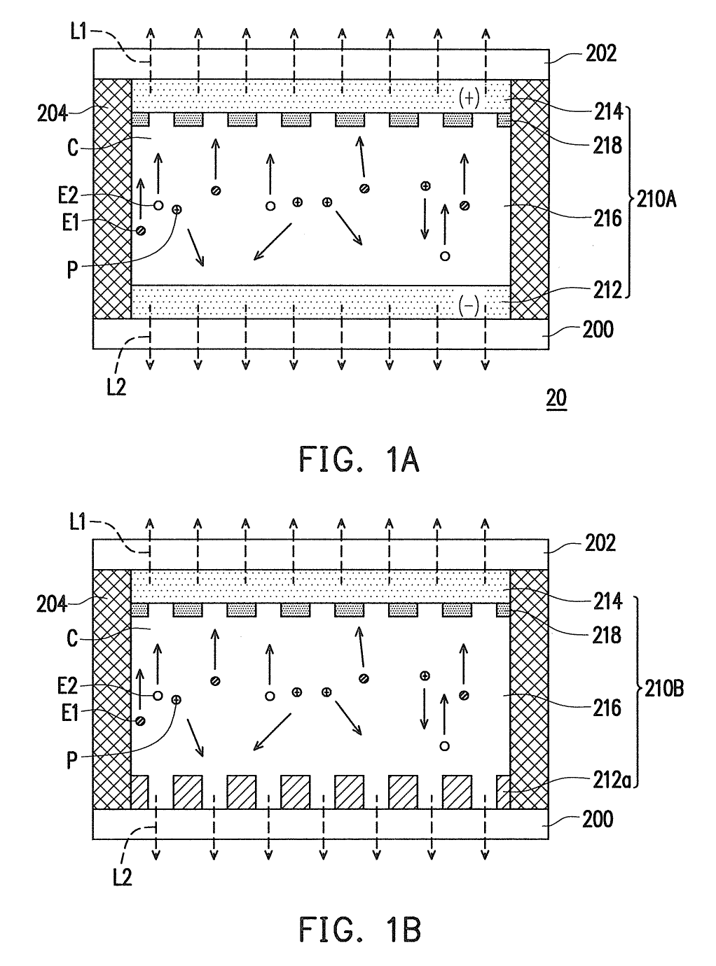

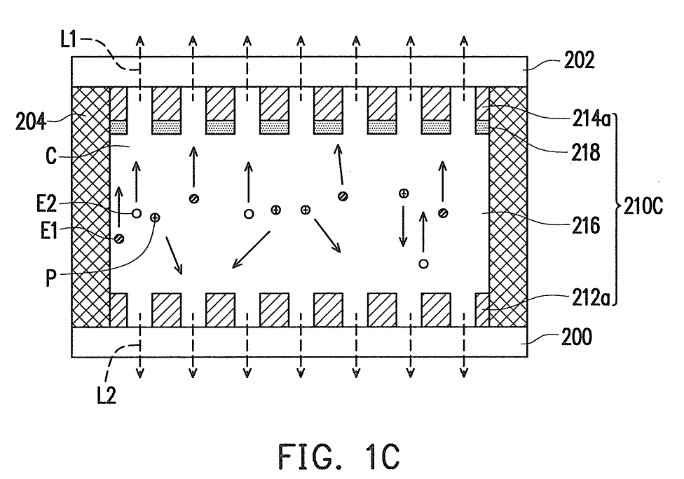

FIGS. 1A through 1C are cross-sectional views of a dual-purpose light-penetrating and light-emitting device, according to three embodiments of the present invention, respectively. Referring to FIGS. 1A through 1C, a dual-purpose light-penetrating and light-emitting device 20 includes a first transparent substrate 200, a second transparent substrate 202, a spacing sidewall 204, and a light-penetrative illuminating structure 210A, 210B, or 210C. The first transparent substrate 200 and the second transparent substrate 202 for example are made of a transparent glass (or an anti-ultraviolet glass; anti-UV glass). The spacing sidewall 204 defines hermetic space C between the first transparent substrate 200 and the second transparent substrate 202. The hermetic space C has a structure like a conventional hermetic laminated glass which is often used as a building material. Such a hermetic space C has a good weatherability (heat isolation and preservation). The hermetic space C contains very thin gas therein, and therefore there is almost no thermal conduction and thermal convection of gas existed therein. As such, the hermetic space C is adapted for providing a good heat isolation and preservation effect. Meanwhile, the dual-purpose light-penetrating and light-emitting device 200 also achieves the effect of sound insulation and low condensation.

According to one embodiment, the light-penetrative illuminating structure 210A as shown in FIG. 1A adopts the light-emitting mechanism of a FEEL. The illuminating structure 210A includes a cathode structure 212, an anode structure 214, a low pressure gas layer 216, and a patterned fluorescent layer 218. The cathode structure 212 and the anode structure 214 for example are made of transparent conductive layers for achieving the light-penetrative capability. According to another embodiment, the light-penetrative illuminating structure 210B as shown in FIG. 1B includes a cathode structure 212a, an anode structure 214, a low pressure gas layer 216 and a patterned fluorescent layer 218. The cathode structure 212a for example is made of a light-penetrative patterned metal layer for achieving the light-penetrative capability. According to a further embodiment, the light-penetrative illuminating structure 210C as shown in FIG. 1C includes a cathode structure 212a, an anode structure 214a, a low pressure gas layer 216 and a patterned fluorescent layer 218. The anode structure 214a for example is made of a light-penetrative patterned metal layer for achieving the light-penetrative capability.

In the foregoing embodiments as shown in FIGS. 1A through 1C, except that the cathode structure and/or the anode structure (represented by different legends) thereof may be different, the rest elements (represented by same legends) of the embodiments are same. Specifically, the cathode structure 212 or 212a is disposed on the first transparent substrate 200, and the anode structure 214 or 214a is disposed on the second transparent substrate 202. The spacing sidewall 204 is disposed between the first transparent substrate 200 and the second transparent substrate 202, and defines the hermetic space C for accommodating the low pressure gas layer 216. The low pressure gas layer 216 accommodated in the hermetic space C has a pressure for example in a range of 10 to 10⁻³ torr. The gas of the low pressure gas layer 216 is selected from the group consisting of an inert gas, air, hydrogen (H₂), carbon dioxide (CO₂), and oxygen (O₂). The inert gas can be nitrogen (N₂), helium (He), neon (Ne), argon (Ar), krypton (Kr), or xenon (Xe).

In the foregoing embodiments, the transparent conductive layer for example is made of indium tin oxides (ITO), indium zinc oxides (IZO), fluorine-doped tin oxide (FTO), aluminium-doped zinc oxide (AZO), or other transparent conductive oxides having a light-penetrative characteristic. The patterned metal layer for example is made of copper alloy, or aluminium alloy. The patterned metal layer for example is strip shaped or net shaped. The linewidth and the space between two adjacent lines can be determined according to practical requirements, and are related with the conditions such as the pressure of the low pressure gas layer 216, the space between the cathode structure and the anode structure, the material of making the cathode structure and the anode structure, and the aperture ratio. Further, the patterned fluorescent layer 218 for example is strip shaped, net shaped, or dot shaped, and is disposed on the transparent conductive layer. The patterned fluorescent layer 218 can be configured by a single layer of fluorescent powder or a stack of a plurality of different fluorescent powder layers, for generating a monochromatic color or a mixed light (white light obtained by mixing different color lights). Further, except visible color materials, the patterned fluorescent layer 218 can also be made of infrared ray (IR) material or UV material.

The patterned fluorescent layer 218 has the strip shaped, net shaped, or dot shaped patterns which are light-penetrative, and the cathode structure and the anode structure are transparent conductive layers or light-penetrative patterned metal layers. As such, fluorescent lights L1 and L2 generated by the patterned fluorescent layer 218 or ambient natural light are allowed to penetrate the first transparent substrate 200, the second transparent substrate 202, the cathode structure, and the anode structure. In such a way, the dual-purpose light-penetrating and light-emitting device 20 achieves the light-penetrating effect and the light-emitting effect. Therefore, the dual-purpose light-penetrating and light-emitting device 20 is not only adapted for allowing the daytime natural light to penetrate therethrough for saving the electricity for illumination, but also adapted for providing an illumination for indoor use or outdoor use in the night.

In FIGS. 1A through 1C, the cathode structure 212 or 212a, and the anode structure 214 or 214a are light-penetrative structures disposed oppositely, respectively. Generally, the patterned fluorescent layer 218 can be disposed between the cathode structure and the anode structure, and is preferably disposed on the anode structure 214 or 214a. The low pressure gas layer 216 are filled between the cathode structure and the anode structure, and is adapted for making the cathode 212 or 212a more likely to uniformly emit the electrons E1. Further, the low pressure gas layer 216 has a mean free path, allowing a sufficient quantity of electrons E1 controlled by an operation voltage to accelerately move toward the anode structure 214 or 214a. The electrons E1 directly bombard the patterned fluorescent layer 218 for emitting light. Further, the low pressure gas layer 216 further contains some dissociative positive ions P. the dissociative positive ions P bombard the cathode structure 212 or 212a, and generate some secondary electrons thereby, thus increasing the quantity of the electrons.

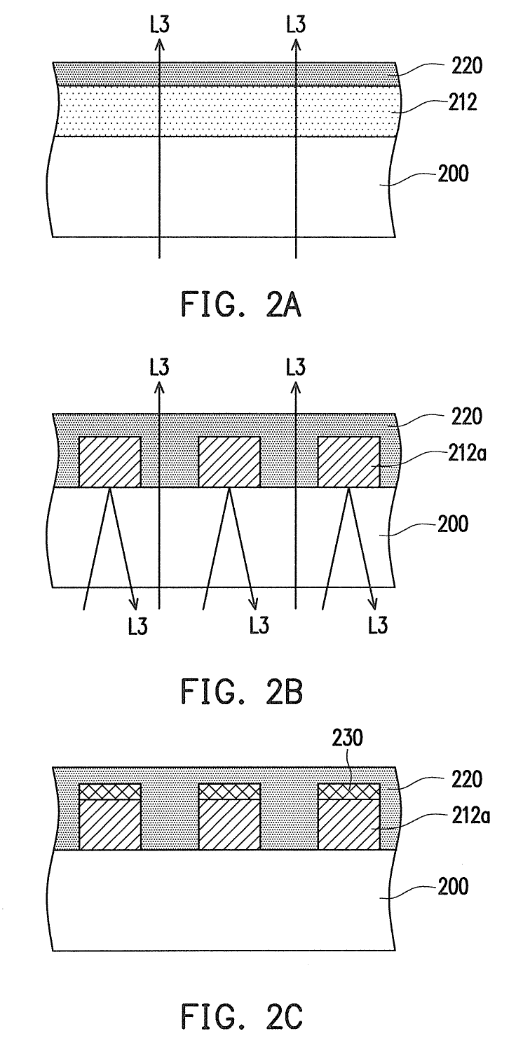

FIGS. 2A through 2C are cross-sectional views of a cathode structure, according to three embodiments of the present invention, respectively. Referring to FIGS. 2A and 2B, a transparent protection layer 220 adapted for generating secondary electrons is further provided on the first transparent substrate 200. The transparent protection layer 220 for example can be made of magnesium oxide (MgO), silicon dioxide (SiO₂), terbium oxide (Tb₂O₃), lanthanum oxide (La₂O₃), aluminium oxide (AL₂O₃), or cerium oxide (CeO₂) for covering the cathode structure 212 or 212a, and is adapted for increasing secondary electrons and providing a protection. Further, referring to FIG. 2C, an electron-emitting layer 230 is additionally provided on the cathode structure 212 or 212a. The electron-emitting layer 230 for example is made of carbon nanotubes, carbon nanowalls, carbon nanoporous, column shaped ZnO, ZnO, or diamond film, or other electron emissive materials. The electron-emitting layer 230 is adapted for facilitating the cathode to emit electrons and lowering the operation voltage of the cathode.

In the foregoing embodiments, the electron emissive material can be but is not restricted to be provided on the cathode structure 212 or 212a. According to an embodiment which is unshown in the drawings, the electron emissive material is disposed on the anode structure 214 or 214a, and is also adapted for facilitating emit electrons. Further, the anode structure 214 or 214a can also be additionally provided with a transparent protection layer which is adapted for generating secondary electrons. The additionally provided transparent protection layer covers the patterned fluorescent layer 218, and is adapted for preventing the fluorescent powders from being burned out by the electrons bombarding thereon. In such a way, the lifespan of the patterned fluorescent layer 218 can be improved. It should be noted that the additionally provided embodiments are given to illustrate more combinations and modifications between the aforementioned embodiments and are not for restricting the scope of the present invention.

The two embodiments of FIGS. 2A and 2B are different in that the cathode structure 212 is a plane shaped light-penetrative transparent conductive layer allowing the natural light L3 penetrating therethrough and having an aperture ratio of 100%, while the cathode structure 212a is a strip shaped or net shaped patterned metal layer allowing only a part of the natural light L3 penetrating therethrough and having an aperture less than 100%. The aperture of the cathode structure 212a is determined by the linewidth and the space between two adjacent lines.

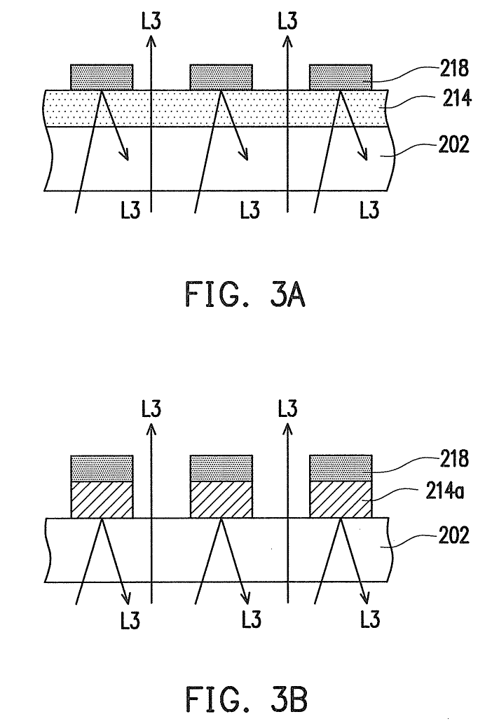

FIGS. 3A and 3B are cross-sectional views of an anode structure, according to two embodiments of the present invention, respectively. In order to allow the natural light L3 penetrating therethrough, the patterned fluorescent layer 218 partially covers a part of the second transparent substrate 202, rather than covers the entirety of the second transparent substrate 202. Referring to FIG. 3A, the anode structure 214 is disposed between the patterned fluorescent layer 218 and the second transparent substrate 202. The anode structure 214 for example is a plane shaped transparent conductive layer allowing the natural light penetrating therethrough. However, a part of the natural light is sheltered by the patterned fluorescent layer 218. As such, the aperture ratio of the embodiment of FIG. 3A is less than 100%. Referring to FIG. 3B, the anode structure 214a is disposed between the patterned fluorescent layer 218 and the second transparent substrate 202. The anode structure 214a for example is a strip shaped or net shaped patterned metal layer. A part of the natural light is sheltered by the anode structure 214a and the patterned fluorescent layer 218. As such, the aperture ratio of the embodiment of FIG. 3B is also less than 100%.

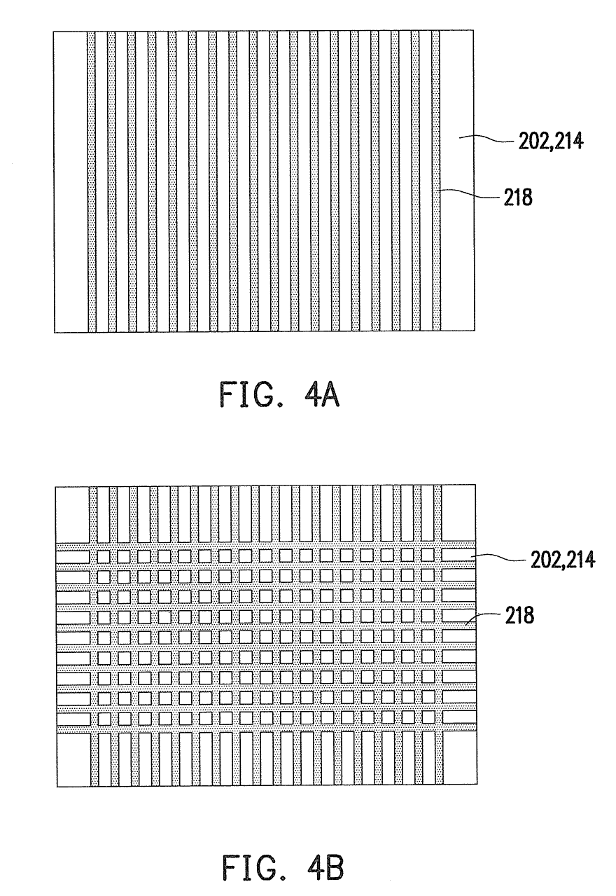

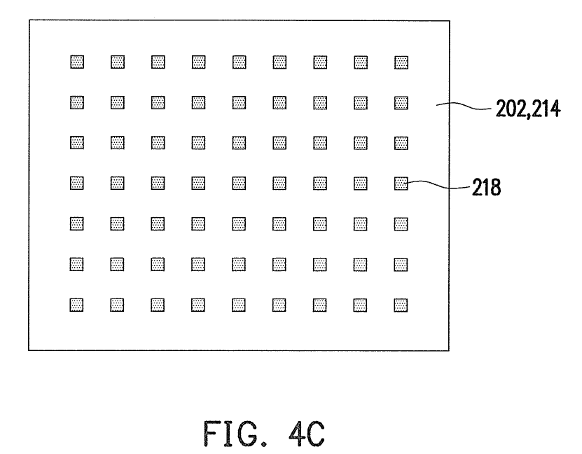

FIGS. 4A through 4C are top views of a patterned fluorescent layer, according to three embodiments of the present invention without restricting the scope of the present invention. Referring to FIGS. 4A through 4C, the patterned fluorescent layer 218 can be strip shaped (configured with parallel or nonparallel lines), net shaped (parallel and perpendicularly crossing lines), dot shaped (array or randomly distributed dots), or configured with a combination of triangle shapes, round shapes, square shapes, rectangular shapes. As to the shape of the cathode structure and/or the anode structure, although they are not specifically illustrated hereby, those skilled in the art would have been taught by the related illustration of the foregoing embodiments to design the cathode structure and the anode structure in accordance with the shape of the patterned fluorescent layer, and the details are not to be iterated hereby.

In summary, the present invention employs the patterned fluorescent layer for emitting light, and is adapted for saving electricity power, and achieving the light-penetrating and light-emitting performances. The cathode structure and the anode structure can be designed as plane shaped structures, which are simple and do not require for specific processing. Further, the present invention provides improved performances in scenario, illumination, and power saving aspects, and is not only adapted for scenario illumination, but also adapted for saving energy. Taking a glass curtain wall of a commercial building as an example, when the present invention is applied, the light-penetrating and heat isolation features function during the daytime thus saving much electricity consumed by air conditioners and illumination, and the double emission feature function during the evening and the night for provide advertising applications or building illumination. As such, the present invention is commercially valuable for both of daytime and night time applications.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A dual-purpose light-penetrating and light-emitting device, comprising:
a first transparent substrate,
a spacing sidewall,
a second transparent substrate, wherein the spacing sidewall is disposed between the first transparent substrate and the second transparent substrate for configuring a hermetic space; and
a light-penetrative illuminating structure, comprising a cathode structure, an anode structure, a low pressure gas layer, and a patterned fluorescent layer,
wherein the low pressure gas layer is accommodated in the hermetic space, the cathode structure and the anode structure are oppositely disposed on the first transparent substrate and the second transparent substrate, respectively, and the patterned fluorescent layer is positioned between the cathode structure and the anode structure, for allowing an ambient natural light penetrating therethrough.

2. The dual-purpose light-penetrating and light-emitting device according to claim 1, wherein the anode structure comprises a first patterned metal layer disposed between the patterned fluorescent layer and the second transparent substrate.

3. The dual-purpose light-penetrating and light-emitting device according to claim 2, wherein the first patterned layer is strip shaped, or net shaped, and the patterned fluorescent layer is strip shaped, net shaped, or dot shaped.

4. The dual-purpose light-penetrating and light-emitting device according to claim 1, wherein the anode structure comprises a first transparent conductive layer disposed between the fluorescent layer and the second transparent substrate.

5. The dual-purpose light-penetrating and light-emitting device according to claim 4, wherein the first transparent conductive layer is strip shaped, net shaped, or plane shaped, and the patterned fluorescent layer is strip shaped, net shaped, or dot shaped.

6. The dual-purpose light-penetrating and light-emitting device according to claim 1, wherein the cathode structure includes a second patterned metal layer, and the second patterned metal layer is strip shaped or net shaped.

7. The dual-purpose light-penetrating and light-emitting device according to claim 1, wherein the cathode structure includes a second transparent conductive layer, and the second transparent conductive layer is strip shaped, net shaped, or plane shaped.

8. The dual-purpose light-penetrating and light-emitting device according to claim 1, further comprising a transparent protection layer disposed on the first transparent substrate for covering the cathode structure.

9. The dual-purpose light-penetrating and light-emitting device according to claim 8, wherein the transparent protection layer is made of magnesium oxide (MgO), silicon dioxide (SiO₂), terbium oxide (Tb₂O₃), lanthanum oxide (La₂O₃), aluminium oxide (AL₂O₃), or cerium oxide (CeO₂).

10. The dual-purpose light-penetrating and light-emitting device according to claim 1, further comprising an electron-emitting layer disposed on the cathode structure.

11. The dual-purpose light-penetrating and light-emitting device according to claim 10, wherein the electron-emitting layer is made of carbon nanotubes, carbon nanowalls, carbon nanoporous, zinc oxide (ZnO), or a diamond film.

12. The dual-purpose light-penetrating and light-emitting device according to claim 1, wherein the low pressure gas layer has a pressure ranging from 10 to 10⁻³ torr.

13. A light-penetrative illuminating structure, comprising:
a cathode structure,
an anode structure, wherein the cathode structure and the anode structure are parallel and spaced for a distance one to another;
a patterned fluorescent layer, positioned between the cathode structure and the anode structure, allowing an ambient natural light penetrating therethrough; and
a low pressure gas layer, filled between the cathode structure and the anode structure, for inducing the cathode structure to emit a sufficient quantity of electrons.

14. The light-penetrative illuminating structure according to claim 13, wherein the anode structure comprises a first patterned metal layer, the first patterned metal layer is strip shaped or net shaped.

15. The light-penetrative illuminating structure according to claim 13, wherein the anode structure comprises a first transparent conductive layer, and the first transparent conductive layer is strip shaped, net shaped, or plane shaped.

16. The light-penetrative illuminating structure according to claim 13, the fluorescent layer is strip shaped, net shaped or dot shaped.

17. The light-penetrative illuminating structure according to claim 13, wherein the cathode structure comprises a second patterned metal layer, and the second patterned metal layer is strip shaped or net shaped.

18. The light-penetrative illuminating structure according to claim 13, wherein the cathode structure comprises a second transparent conductive layer, and the second transparent conductive layer is strip shaped, net shaped, or plane shaped.

19. The light-penetrative illuminating structure according to claim 13, further comprising a transparent protection layer for covering the cathode structure.

20. The light-penetrative illuminating structure according to claim 13, further comprising an electron-emitting layer disposed on the cathode structure.
